(19) United States
(12) Patent Application Publication
(10) Pub. No.: US 2006/0227177 A1
(43) Pub. Date: Oct. 12, 2006

(54) Diaphragm plate with partially-etched port

(75) Inventors: Dan Leo Massopust, Powell Butte, OR (US); Garry Adam Jones, Sherwood, OR (US); Scott Taylor Treece, Portland, OR (US); Richard Schmachtenberg, Aloha, OR (US)

Correspondence Address: MARGER JOHNSON & MCCOLLOM, P.C., 210 SW MORRISON STREET, SUITE 400, PORTLAND, OR, 97204, US

(73) Assignee: Xerox Corporation

(21) Appl. No.: 11/101,763

(22) Filed: Apr. 7, 2005

(51) Int. Cl. B41J 2/05

(52) U.S. Cl. 347/56

(57) ABSTRACT

A printhead assembly that includes a partially-etched port structured to be opened by application of pressure to the port area, one or more leaflets being depressed into an internal chamber communicating with the open port.

### BACKGROUND

Drop on demand ink jet technology for producing printed media has been employed in commercial products such as printers, plotters, and facsimile machines. Generally, an ink jet image is formed by selective placement on a receiver surface of ink drops emitted by a plurality of drop generators implemented, for example, in a printhead comprising a stack of metal plates having fluidic chambers and channels formed therein (commonly referred to as a jet stack assembly). Ink is stored in an ink reservoir and loaded into the printhead assembly through ports in a diaphragm plate on the back side of the printhead assembly.

In printhead assembly manufacture, ports are formed in the diaphragm prior to incorporation of the diaphragm into the jet stack assembly. Ports typically are formed by etching through the diaphragm.

Some printhead assembly manufacturing methods may require that the diaphragm have no open ports during the processing of the printhead.

### BRIEF DESCRIPTION OF DRAWINGS

FIG. 1 is a cross-sectional side view diagram of a jet stack assembly for a printhead.

FIG. 2 is a plan view diagram of the jet stack assembly of FIG. 1.

FIG. 3 is a plan view diagram of a first embodiment of a partially-etched port.

FIG. 4 is a plan view diagram of the first embodiment partially-etched port after piercing.

FIG. 5 is a cross-sectional side view diagram of the partially-etched port of FIG. 4 after piercing.

FIG. 6 is a plan view diagram of a second embodiment of a partially-etched port.

FIG. 7 is a plan view diagram of the second embodiment partially-etched port after piercing.

FIG. 8 is a cross-sectional side view diagram of the partially-etched port of FIG. 7 after piercing.

### DETAILED DESCRIPTION

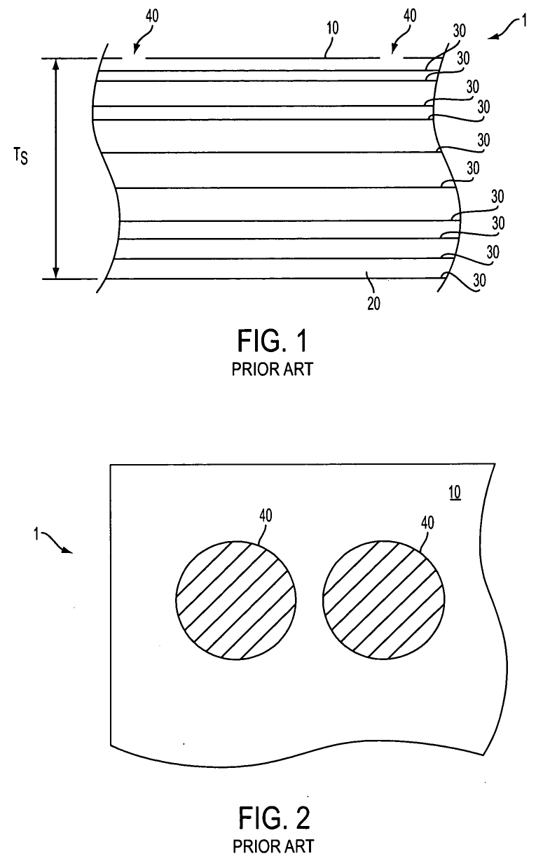

FIGS. 1 and 2 are cross-sectional side and plan view diagrams, respectively, of a printhead assembly 1 for a printhead. The printhead assembly 1 includes a diaphragm plate 10, aperture plate 20, and body 30 intermediate the aperture plate 20 and diaphragm plate 10. The printhead assembly 1 has a thickness T_{S}, which can be generally on the order of 90 mils.

By way of illustrative example, a diaphragm plate (or diaphragm) 10 of a printhead assembly 1 generally includes ports 40 permitting communication of a reservoir (not shown) and chambers 42 within the printhead assembly 1. Ports 40 can be curved in shape, with an exemplary circular port having a diameter D_{P} of less than 10 mils but not greater 250 mils.

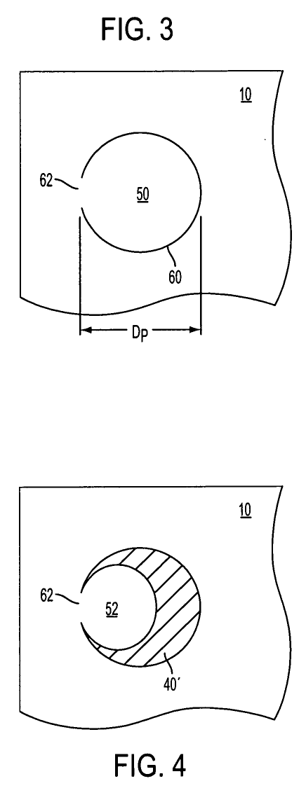

FIG. 3 is a plan view diagram of a first embodiment partially-etched port trace 50 formed on a diaphragm 10 of a printhead assembly 1. By way of illustrative example, this embodiment includes a curved port perimeter or port boundary having a partially-etched arc 60 comprising a substantial portion thereof partially-etched into the diaphragm plate 10 material. A non-etched hinge region 62 remains at the remaining portion of the curved port boundary. In this embodiment, the partially-etched arc 60 comprises about 90% of the port boundary, although a greater or lesser percentage may be efficaciously employed.

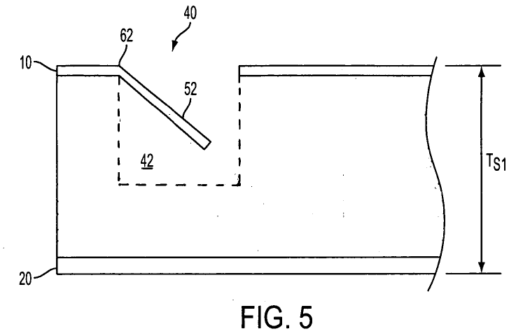

FIGS. 4 and 5 are plan and cross-sectional side view diagrams showing the port 40 of FIG. 3 after piercing. When pressure is applied to the port area 50, the diaphragm plate 10 fractures along the partially-etched arc 60. A port 40 is opened thereby and a leaflet 52 is formed by the depressed or pierced portion of the diaphragm plate 10.

The leaflet 52 generally is disposed at an angle to the diaphragm plate 10 after depression. It is readily appreciated that the leaflet 52 can be deflected out of the plane of the diaphragm plate 10, while the non-etched hinge region 62 retains the leaflet 52 and thereby prevents it from breaking off.

The material used to make the diaphragm plate 10 may permit the leaflet 52 to rebound slightly after depression. The hinge region 62 can be configured to provide maximum deflection of the leaflet 52 without fracture of the hinge region 62 for a given diaphragm plate 10 material.

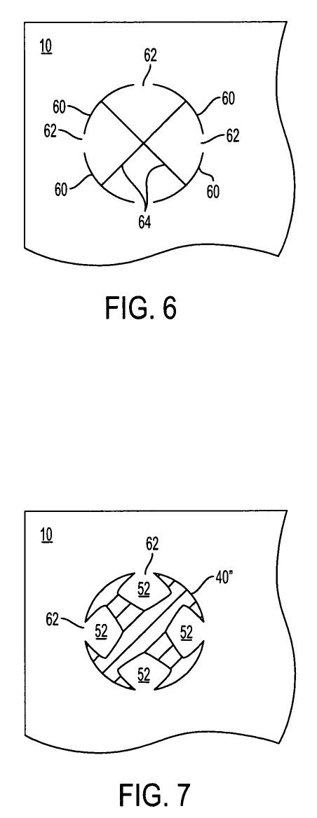

FIG. 6 is a plan view diagram of a second embodiment of a partially-etched port trace formed on a diaphragm plate 10. By way of illustrative example, the partial-etching in this embodiment includes a curved port boundary having four port boundary partial-etches 60 partially etched thereon into the diaphragm plate 10 material. Corresponding four non-etched port boundary hinges 62 remain at the curved port boundary or port perimeter. Two generally linear partial-etches 64 are further partially-etched, each generally linear partial-etch in this embodiment extending across the port boundary and connecting two port boundary partial-etches.

It should be appreciated that the above partial-etching yields a quartet of partially-etched areas 52. An individual leaflet 52 can be pie-, V- or wedge-shaped, and either of the leaflet 52 or the port trace can be considered a partially-etched predetermined portion.

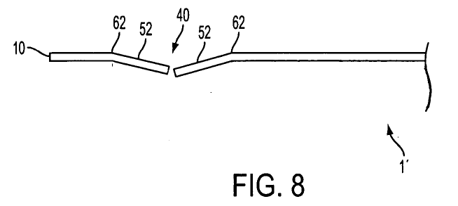

FIGS. 7 and 8 are plan and cross-sectional side view diagrams of the open port 40 of FIG. 6 after piercing or depression. After pressure was applied to the port area 50 from a side of the diaphragm 10, the diaphragm plate 10 material fractured along the port boundary partial-etches 60 and generally linear partial-etch 64. The port 40 was opened thereby and leaflets 52 were formed by the depressed or pierced portions of the diaphragm plate 10. The depressed leaflets 52 reside out of the plane of the diaphragm plate 10. For an embodiment wherein the diaphragm plate 10 is attached to a printhead body 30 having a fluidic chamber 42 therein, it will be appreciated that the leaflets 52 may be deflected into the body and toward the chamber 42.

The number of port boundary partial-etches 60 in the second embodiment need not be limited to four. In other embodiments, partially-etched arcs and an alternating non-etched arcs can be disposed on the diaphragm plate 10. Generally linear partial-etches 64 would be partially-etched, each generally linear partial-etch 64 disposed within the port area 50 and connecting to at least one partially-etched arc 60 on the port boundary.

By way of further illustrative example, an embodiment (not shown) similar to the embodiment of FIG. 6 may be formed having three partially-etched arcs and three radial and generally linear partial-etches, with each generally linear partial-etch extending generally from the central region of the port boundary to a partially-etched arc. It should be understood that a variety of partially-etched arc/generally linear partial-etch configurations may be employed to generate various multi-leaflet structures, and that such variations and multi-leaflet structures are within the scope of the present disclosure.

In a further embodiment, partial etching is performed on the reverse or second side of the diaphragm 10. This partial etching may but is not required to mimic the etching of the first side of the diaphragm 10. By way of example, the non-partially-etched hinge region 62 may be partially etched on a reverse side of the diaphragm 10 to facilitate hinging or to promote hinging in a specific locus or pattern.

An advantage of the present port trace 50 is that the port traces 50 are shaped in the partial-etching step and pierced to form an open port 40. The present method therefore permits utilization of elliptical, crenate or other port boundary shapes as desired.

Similarly, it is not necessary that the partially-etched arcs be of equal length; partial-etches of different lengths may be employed, resulting in non-equal leaflets. Moreover, the generally linear partial-etch of FIGS. 6-8 need not be generally linear, but may instead be partially-etched in an arcuate or curvilinear configuration. Such leaflet variations may be used to affect flow characteristics of ink through the open port and into the fluidic chamber.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A drop emitting apparatus comprising:
a body containing fluid chambers and fluid channels;
a diaphragm plate structured to be attached to the body;
the diaphragm plate including a predetermined region defined by a perimeter, the predetermined region including a partially-etched portion and a non-etched perimeter portion.

2. The drop emitting apparatus of claim 1 wherein the partially-etched predetermined region includes a partially-etched perimeter portion.

3. The drop emitting apparatus of claim 2 wherein the partially-etched perimeter portion is at least one of generally circular, generally oval-shaped, arcuate, or generally linear.

4. The drop emitting apparatus of claim 2 wherein the partially-etched predetermined region includes a partially-etched line intersecting the partially-etched perimeter portion.

5. The drop emitting apparatus of claim 1 wherein the partially-etched predetermined region defines a generally V-shaped segment.

6. The drop emitting apparatus of claim 1 wherein the diaphragm plate further includes a second partially-etched perimeter portion in a second predetermined region on a second side of the diaphragm plate.

7. The drop emitting apparatus of claim 1 wherein the perimeter region is fractured at the partially etched perimeter portion and bent at the non-etched perimeter portion.

8. The drop emitting apparatus of claim 7 wherein the non-etched perimeter portion is structured to prevent separation of the diaphragm plate and a leaflet defined by the partial-etched portion.

9. The drop emitting apparatus of claim 1 wherein the diaphragm plate is attached to the body.

10. A printhead, comprising:
an aperture plate on a front side of the printhead;
a diaphragm plate on a back side of the printhead;
a body intermediate the aperture plate and the diaphragm plate;
a chamber disposed within the body;
a port boundary defining a port area, the port boundary disposed on the diaphragm plate and adjacent the chamber;
a peripheral partially-etched region coinciding with a first portion of the port boundary; and
a peripheral non-etched region coinciding with a second portion of the port boundary;
wherein the port boundary is structured to fracture upon an application of pressure from the back side to form an open port communicating with the chamber and a leaflet disposed at least partially within the chamber.

11. The printhead of claim 10, further comprising:
a discontinuous plurality of partially-etched arcs; and
a plurality of internal partial-etches, each extending from a point in the port area to a peripheral partially-etched arc.

12. The printhead of claim 10 wherein the peripheral partially-etched region is curved.

13. The printhead of claim 12 wherein the peripheral partially-etched region is circular and has a diameter which is greater than a thickness of the printhead.

14. The printhead of claim 12 wherein the diameter is in the range of about 15 mils to about 100 mils.

15. The printhead of claim 10 wherein a fractured port boundary forms an open port communicating with the chamber and a leaflet disposed at least partially within the chamber.

16. A method for creating an opening in a diaphragm of a printhead, comprising:
partially-etching a port trace on the diaphragm; and
preserving a non-etched hinge in the port trace;
wherein the partially-etched port trace and the non-etched hinge define a port leaflet.

17. The method of claim 16 wherein partially-etching the port trace comprises:
partially-etching a plurality of discontinuous port boundary partial-etches along a port boundary defining a port area; and
partially-etching an internal partial-etch.

18. The method of claim 16 wherein partially-etching the port trace comprises partially-etching a continuous port boundary disposed along less than all of a port boundary defining a port area.

19. The method of claim 16, further comprising:
attaching the diaphragm plate to a printhead body subsequent to partially-etching.

20. The method of claim 19, further comprising:
fracturing the diaphragm along the port traces; and
deflecting the port leaflet out of a diaphragm plane.

21. The method of claim 20 wherein deflecting the port leaflet comprises hingeably deflecting the leaflet out of the diaphragm plane.

22. The method of claim 20 wherein deflecting the port leaflet comprises deflecting the leaflet out of the diaphragm plane and avoiding contact between the leaflet and structures adjacent a side of the diaphragm plane to which the leaflet is deflected.

23. A method for forming a port in a printhead, comprising:
providing a diaphragm plate structured to be attached to a printhead body containing fluid chambers and channels;
defining a first predetermined region on the diaphragm plate; and
partially-etching the first predetermined region to define a first port trace.

24. The method of claim 23 wherein the first predetermined region is defined by a perimeter and the first port trace includes a partially-etched perimeter segment and a non-etched perimeter segment.

25. The method of claim 24 wherein the partially-etched perimeter segment has a general shape selected from the group consisting of circular, oval shaped, pie shaped and curvilinear.

26. The method of claim 25, further comprising:
attaching the diaphragm plate to the printhead body.

27. The method of claim 26, further comprising:
fracturing the diaphragm plate at the first predetermined region; and
bending the diaphragm plate at the non-etched perimeter segment.

28. The method of claim 26, further comprising:
partially-etching a subset of a port area defined by the port perimeter; and
fracturing at the partially-etched subset of the port area.
